(19) United States
(12) Patent Application Publication
(10) Pub. No.: US 2026/0313733 A1
(43) Pub. Date: Oct. 8, 2026

(54) CELL ACCESS SCHEMES FOR NETWORK ENERGY SAVINGS

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Jianghong LUO, Skillman, NJ (US); Karl Georg HAMPEL, Jersey City, NJ (US); Junyi LI, Greentown, PA (US)

(21) Appl. No.: 19/171,948

(22) Filed: Apr. 7, 2025

(51) Int. Cl. H04W 76/18; H04W 28/02; H04W 74/0833

(52) U.S. Cl. CPC H04W 76/18; H04W 28/0221; H04W 74/0833

(57) ABSTRACT

This disclosure provides methods, components, devices and systems for cell access schemes for network energy savings. For example, a user equipment (UE) may transmit a random access message to an anchor network entity that request activation of one or more inactive cells, such as a cell operating in accordance with network energy savings (NES) techniques. A signaling field may be added to one or more random access messages to allow a UE to include one or more parameters associated with the request to activate the inactive cell, such as a cell ID or a beam ID of an inactive cell. An anchor cell that receives the request may coordinate with the inactive cell to activate the cell, and provide communications between the UE and the previously inactive cell.

### TECHNICAL FIELD

This disclosure relates generally to wireless communication, and more specifically to systems, devices, methods, and techniques associated with cell access schemes for network energy savings.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include transmitting a random access message to a first cell, where the random access message includes a request to establish a connection with a second cell that is different than the first cell, where the second cell is unavailable for a random access procedure, receiving a response message from the first cell that indicates an availability of the second cell for the connection with the UE, and establishing, subsequent to reception of the response message, the connection with the second cell.

A UE for wireless communications is described. The UE may include a processing system that includes processor circuitry and memory circuitry that stores code. The processing system may be configured to cause the UE to transmit a random access message to a first cell, where the random access message includes a request to establish a connection with a second cell that is different than the first cell, where the second cell is unavailable for a random access procedure, receive a response message from the first cell that indicates an availability of the second cell for the connection with the UE, and establish, subsequent to reception of the response message, the connection with the second cell.

Another UE for wireless communications is described. The UE may include means for transmitting a random access message to a first cell, where the random access message includes a request to establish a connection with a second cell that is different than the first cell, where the second cell is unavailable for a random access procedure, means for receiving a response message from the first cell that indicates an availability of the second cell for the connection with the UE, and means for establishing, subsequent to reception of the response message, the connection with the second cell.

A non-transitory computer-readable medium storing code for wireless communications is described. The code may include instructions executable by one or more processors to transmit a random access message to a first cell, where the random access message includes a request to establish a connection with a second cell that is different than the first cell, where the second cell is unavailable for a random access procedure, receive a response message from the first cell that indicates an availability of the second cell for the connection with the UE, and establish, subsequent to reception of the response message, the connection with the second cell.

In some examples of the method, UEs, and non-transitory computer-readable medium described herein, the random access message indicates one or more of a selected beam or a measurement report parameter associated with the second cell, the selected beam or the measurement report parameter based on a prior measurement of the second cell performed at the UE. In some examples of the method, UEs, and non-transitory computer-readable medium described herein, the response message from the first cell may be a random access response that provides information for establishment of the connection with the second cell.

In some examples of the method, UEs, and non-transitory computer-readable medium described herein, the request to establish the connection with the second cell may be transmitted in a first random access message or a third random access message of a four-step random access procedure, or in an initial random access message of a two-step random access procedure. In some examples of the method, UEs, and non-transitory computer-readable medium described herein, the request to establish the connection with the second cell indicates one or more capabilities of the UE associated with one or more characteristics of the second cell, the one or more capabilities including one or more of a sixth-generation (6G) communications capability, one or more supported frequency ranges of the UE, or one or more supported network energy savings features.

Some examples of the method, UEs, and non-transitory computer-readable medium described herein may further include operations, features, means, or instructions for receiving, from the first cell prior to transmission of the request to establish the connection with the second cell, configuration information associated with a random access procedure, where the configuration information indicates the request to establish the connection with the second cell is able to be transmitted in a first random access message or a third random access message of a four-step random access procedure, or in an initial random access message of a two-step random access procedure.

In some examples of the method, UEs, and non-transitory computer-readable medium described herein, the response message indicates the first cell will relay communications between the UE and the second cell until the connection between the UE and the second cell is established. Some examples of the method, UEs, and non-transitory computer-readable medium described herein may further include operations, features, means, or instructions for establishing a security context with the second cell in accordance with communications between the UE and the second cell that are relayed via the first cell.

A method for wireless communications by a network entity associated with a first cell is described. The method may include receiving, from a UE, a random access message that includes a request to establish a connection with a second cell that is different than the first cell, where the second cell is unavailable for a random access procedure, transmitting, to the UE, a response message that indicates an availability of the second cell for the connection with the UE, and transmitting one or more messages to the second cell to initiate establishment of the connection between the second cell and the UE.

A network entity associated with a first cell for wireless communications is described. The network entity may include a processing system that includes processor circuitry and memory circuitry that stores code. The processing system may be configured to cause the first cell to receive, from a UE, a random access message that includes a request to establish a connection with a second cell that is different than the first cell, where the second cell is unavailable for a random access procedure, transmit, to the UE, a response message that indicates an availability of the second cell for the connection with the UE, and transmit one or more messages to the second cell to initiate establishment of the connection between the second cell and the UE.

Another network entity associated with a first cell for wireless communications is described. The network entity may include means for receiving, from a UE, a random access message that includes a request to establish a connection with a second cell that is different than the first cell, where the second cell is unavailable for a random access procedure, means for transmitting, to the UE, a response message that indicates an availability of the second cell for the connection with the UE, and means for transmitting one or more messages to the second cell to initiate establishment of the connection between the second cell and the UE.

A non-transitory computer-readable medium storing code for wireless communications is described. The code may include instructions executable by one or more processors to receive, from a UE, a random access message that includes a request to establish a connection with a second cell that is different than the first cell, where the second cell is unavailable for a random access procedure, transmit, to the UE, a response message that indicates an availability of the second cell for the connection with the UE, and transmit one or more messages to the second cell to initiate establishment of the connection between the second cell and the UE.

In some examples of the method, first cells, and non-transitory computer-readable medium described herein, the random access message indicates one or more of a selected beam or a measurement report parameter associated with the second cell, the selected beam or the measurement report parameter based on a prior measurement of the second cell performed at the UE. In some examples of the method, first cells, and non-transitory computer-readable medium described herein, the response message may be a random access response that provides information for establishment of the connection between the UE and the second cell.

In some examples of the method, first cells, and non-transitory computer-readable medium described herein, the request to establish the connection with the second cell may be received in a first random access message or a third random access message of a four-step random access procedure, or in an initial random access message of a two-step random access procedure. In some examples of the method, first cells, and non-transitory computer-readable medium described herein, the request to establish the connection with the second cell indicates one or more capabilities of the UE associated with one or more characteristics of the second cell, the one or more capabilities including one or more of a sixth-generation (6G) communications capability, one or more supported frequency ranges of the UE, or one or more supported network energy savings features.

Some examples of the method, first cells, and non-transitory computer-readable medium described herein may further include operations, features, means, or instructions for transmitting, prior to reception of the request to establish the connection with the second cell, configuration information associated with a random access procedure of the first cell, where the configuration information indicates the request to establish the connection with the second cell is able to be transmitted in a first random access message or a third random access message of a four-step random access procedure, or in an initial random access message of a two-step random access procedure. In some examples of the method, first cells, and non-transitory computer-readable medium described herein, the configuration information indicates a list of cells or frequencies for which the UE can send the request, one or more criteria to be satisfied prior to transmission of the request, or any combination thereof.

In some examples of the method, first cells, and non-transitory computer-readable medium described herein, the response message indicates the first cell will relay communications between the UE and the second cell until the connection between the UE and the second cell are established. In some examples of the method, first cells, and non-transitory computer-readable medium described herein, the second cell establishes a security context with the UE in accordance with communications between the UE and the second cell that are relayed via the first cell.

### BRIEF DESCRIPTION OF THE DRAWINGS

FIG. 1 shows an example of a wireless communication system.

FIG. 2 shows an example of a signaling configuration that supports cell access schemes for network energy savings.

FIG. 3 shows an example of a flowchart that supports cell access schemes for network energy savings.

FIG. 4 shows an example of a process flow that supports cell access schemes for network energy savings.

FIG. 5 shows an example of a relay scheme that supports cell access schemes for network energy savings.

FIG. 6 shows an example of a flowchart that supports cell access schemes for network energy savings.

FIG. 7 shows an example of a process flow that supports cell access schemes for network energy savings.

FIG. 8 shows a block diagram of a processing system that supports cell access schemes for network energy savings.

FIG. 9 shows a diagram of a system including a device that supports cell access schemes for network energy savings.

FIG. 10 shows a block diagram of a processing system that supports cell access schemes for network energy savings.

FIG. 11 shows a diagram of a system including a device that supports cell access schemes for network energy savings.

FIGS. 12 and 13 show flowcharts illustrating methods that support cell access schemes for network energy savings.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, network operators may reduce power consumption by switching some network entities, or some sub-components of some network entities, into an idle or inactive state. For example, network energy savings (NES) techniques may reduce power through idle or inactive periods of one or more cells, and such cells may be activated upon receipt of a wakeup signal (WUS), or some other signaling, from a UE or other network entity. In some cases, a UE may have data that is to be transmitted where activation of an inactive NES cell may substantially enhance throughput and reduce latency. However, in some cases, an inactive cell may be activated after a UE has established a connection with an anchor cell (such as a primary cell (PCell)). In cases where a UE is in idle mode and needs to access the anchor cell through a random access process, the UE may perform a random access process and then the anchor cell may activate the NES cell to provide additional resources to the UE if the anchor cell determines it is unable to meet UE transmission targets. Such procedures may result in some latency between the initial UE random access request and establishment of a connection with the NES cell. Reduction of such latency may help enhance UE and network performance and reduce latency at a UE.

Aspects of the subject matter described in this disclosure relate to activation of inactive cells relatively early in an access procedure for a UE that is accessing a network for communications. For example, in various aspects a UE may send an indication of a request to activate an idle or inactive cell (e.g., a NES cell in an energy savings state) in a random access message to an anchor cell, which may allow the activation of the inactive cell sooner than if the UE connection with the anchor cell had to be established prior to initiating activation of the inactive cell. The request to activate the inactive cell may be provided, for example, in a first random access channel (RACH) message (e.g., MSG1) or a third RACH message (e.g., MSG3) of a 4-step contention-based RACH procedure, or in an initial message (e.g., MSG A) of a 2-step contention-free RACH procedure. In some aspects, a signaling field may be added to the RACH message(s) to allow a UE to include one or more parameters associated with the request to activate the inactive cell. In some aspects, the request to activate the inactive cell may include one or more cell IDs, one or more beam IDs, or any combination thereof, of an inactive cell. In some aspects, the cell ID or beam ID (or both) provided in the random access message may be based on a prior measurement of the inactive cell made at the UE or based on a prior connection between the UE and the inactive cell.

In some aspects, the request from the UE may include a list of one or multiple inactive cells, frequencies, frequency ranges or bands, cell type(s) (e.g., non-terrestrial or terrestrial cells), mobile or stationary cells, or small or macro cells), or supporting special features of a cell (e.g., NES, green/renewable-energy-sourced cells, etc.). The request may additionally, or alternatively, include a list of one or multiple detected or selected cell(s), and may include associated beams (e.g., SSB indices), measured metrics (e.g., reference signal received power (RSRP), reference signal received quality (RSRQ), signal to interference and noise ratio (SINR), and the like), an early indication of UE capabilities (e.g., whether the supports 6G, certain frequency ranges, or NES features), a UE mobility state, or any combination thereof.

In some aspects, an anchor cell, based on the received request from the UE, may initiate activation of the inactive cell(s), or give the inactive cell(s) an indication to prepare to admit a new UE. In some aspects, the anchor cell may further complete the RACH procedure and establish a security context with the UE, and may transfer the security context to the activated cell. In some aspects, the anchor cell may provide an indication to the UE of whether the request from the UE is accepted or rejected, such as in a RACH message to the UE (e.g., in MSG2 or MSG4 of a four-step RACH procedure or MSG B of a two-step RACH procedure), or in subsequent signaling (e.g., radio resource control (RRC) signaling that is exchanged subsequent to completion of the RACH process).

Additionally, or alternatively, the anchor cell may act as a relay for higher-layer signaling between the UE and the inactive cell. For example, the inactive cell may have idle radio frequency (RF) components but have associated backhaul interfaces that are available for backhaul communications with other network entities. In some aspects, the anchor cell may provide physical (PHY) layer signaling, medium access control (MAC) layer signaling, or both, and relay higher layer communications between the UE and inactive cell via a backhaul interface until the inactive cell can transition its RF components to an operational state and provide lower layer signaling. In some aspects, the relayed communications may include RACH communications, and communications to establish a security context between the UE and the NES cell.

Particular aspects of the subject matter described in this disclosure can be implemented to realize one or more of the following potential advantages. In some examples, by providing a request to access an inactive cell in a random access procedure, the described techniques can be used to reduce latency for activating an inactive cell and provide communications resources of the inactive cell which may enhance data rates and reduce communications latency for a UE. In some examples, by providing one or more metrics, cell IDs, or beam IDs in the request from the UE, a network entity associated with the anchor cell may identify and initiate activation of one or more cells or beams with reduced latency relative to instances where such a request may be provided subsequent to completion of a RACH procedure. Additionally, by providing relayed communications between a UE and higher layers of an inactive cell, and anchor cell may facilitate more efficient connection establishment and security context establishment at the inactive cell.

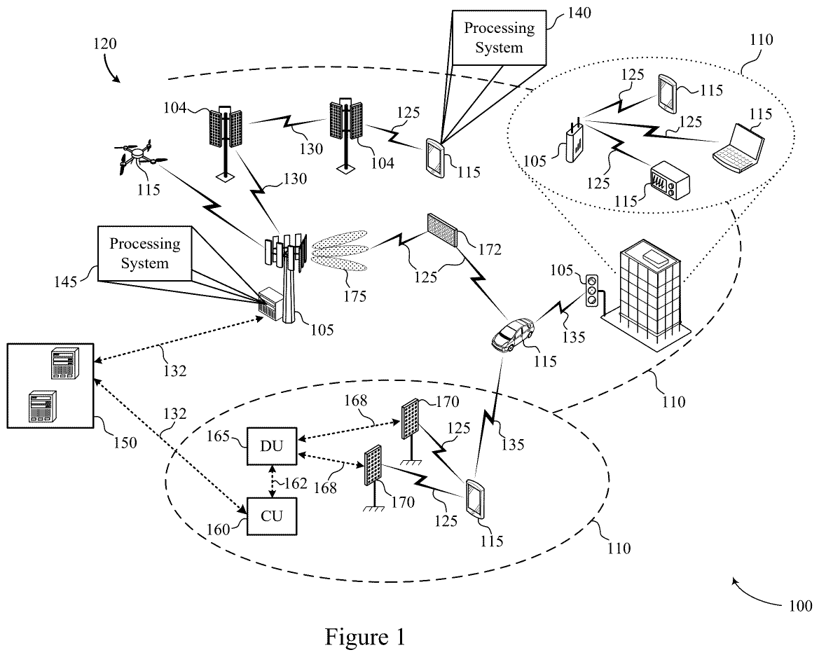

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for cell access schemes for network energy savings. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support transmission of an indication of a UE 115 request to activate an idle or inactive cell (e.g., a NES cell in an energy savings state) in a RACH message to an anchor cell, which may allow the activation of the inactive cell sooner than if the RACH procedure at the anchor cell had to be completed prior to initiating activation of the inactive cell, and thereby reduce latency associated with activation of the inactive cell.

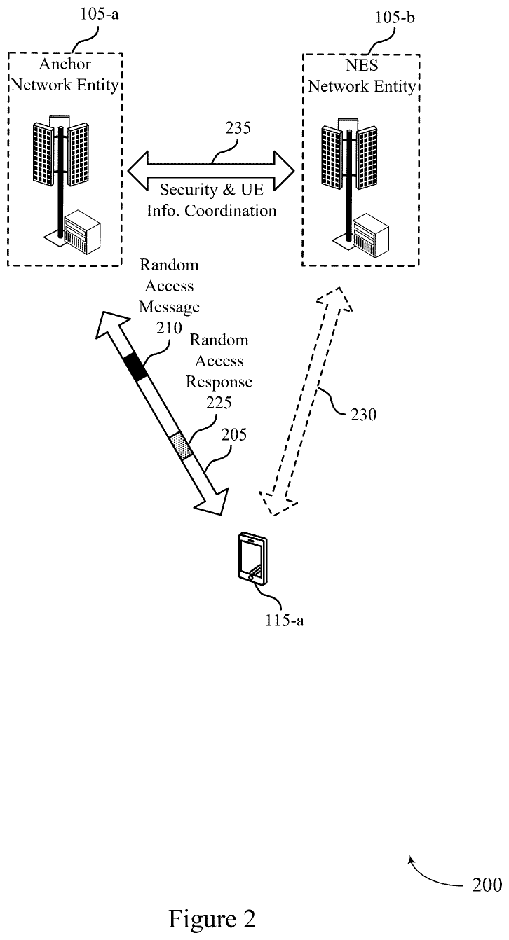

FIG. 2 shows an example of a signaling configuration 200 that supports cell access schemes for network energy savings. The signaling configuration 200 may implement aspects of or may be implemented by aspects of the wireless communications system 100. For example, the signaling configuration 200 includes a UE 115-a, which may be an example of a UE 115 as described herein. The signaling configuration 200 may also include an anchor network entity 105-a and a NES network entity 105-a, which may be examples of network entities 105 as described herein.

In some aspects, the NES network entity 105-b may be associated with one or more NES cells that may be in a lower power state that reduces energy consumption while not serving UEs 115 (e.g., one or more NES cells may be in a state where synchronization signal blocks (SSBs) or system information blocks (SIBs), or both, may be transmitted on-demand in response to a request or wake-up signal (WUS)). In some aspects, one or more NES cells associated with the NES network entity 105-b may or may not be discoverable. The anchor network entity 105-a may have one or more associated anchor cells that have an overlapping coverage with one or more NES cells, and may assist the UE 115-a in accessing a NES cell, such as in cases where the UE desires access to an undiscoverable NES cell. For example, a serving anchor cell associated with the UE 115-a may provide relatively low-throughput for user-plane (UP) traffic exchange, may be associated with a shared network that can assist in accessing neighboring cells but cannot provide UP traffic exchange, may be relatively busy and unable to provide UP traffic exchange, or may be associated with a non-terrestrial networks (NTN) (e.g., a satellite network entity). In some aspects, the UE 115-a may be disconnected camping at the anchor cell, and may desire a relatively fast connection, such as for the sake of a high-throughput UP traffic exchange for downlink or uplink data, or both.

For example, the UE 115-a, while in an idle mode, may determine that data is to be transmitted from the UE 115-a (e.g., based on a user action or data that is provided by an application that is active at the UE 115-a). Further, in some aspects the UE 115-a may identify that an inactive or idle NES cell or beam (or multiple NES cells or beams) associated with the NES network entity 105-b would be likely to provide enhanced communications relative to an anchor cell associated with the anchor network entity 105-a (e.g., based on one or more prior measured channel metrics, or based on a prior connection that was established with a cell associated with the NES network entity 105-b). In order to initiate a connection establishment with an identified NES cell or beam associated with the NES network entity 105-b, the UE 115-a may communicate with the anchor network entity 105-a using associated communication links, such as a communication link 205, which may be an example of a 6G, an NR, or an LTE link between the UE 115-a and the anchor network entity 105-a. The communication link 205 may include bi-directional links that enable both uplink and downlink communications. For example, the anchor network entity 105-a may transmit downlink signals (e.g., downlink transmissions), such as downlink control signaling, downlink RACH messages, and downlink data signals, to the UE 115-a via a downlink portion of communication link 205, and the UE 115-a may transmit uplink signals (e.g., uplink transmissions), such as uplink control signaling, uplink RACH messages, and uplink data signals, to the anchor network entity 105-a using an uplink portion of the communication link 205.

In some aspects, the UE 115-a and the anchor network entity 105-a may perform a random access procedure (e.g., a RACH procedure, a physical random access channel (PRACH) procedure) to initiate a connection between the UE 115-a and one or both of the anchor network entity 105-a and the NES network entity 105-b. In some examples, to facilitate performing such procedures, the network entity 105-a may transmit system information (e.g., system information block (SIB) signaling) that indicates a random access configuration to the UE 115-a, according to which the UE 115-a may perform the random access procedure. In some aspects, the anchor network entity 105-a may configure a four-step contention-based random access procedure, in which the UE 115-a may transmit a random access request (e.g., a RACH preamble in a MSG1 transmission on a PRACH), the anchor network entity 105-a may transmit a random access response (e.g., a MSG2 transmission) in response to the ransom access request, the UE 115-a may transmit a RRC setup request (e.g. a MSG3 transmission) in response to the random access response, and the anchor network entity 105-a may transmit an RRC setup message and contention resolution message (e.g., a MSG4 transmission) in response to the RRC setup request. The UE 115-a may transmit a RRC setup complete message (e.g., a MSG5 transmission) based on the provided RRC setup information. In some aspects, the anchor network entity 105-a may configure a two-step contention-free random access procedure, in which the UE 115-a may transmit a single RACH message (e.g., MSG A transmission) that provides request and RRC setup information, and the anchor network entity 105-a may transmit a single RACH response message (e.g., a MSG B transmission) that provides RACH response and RRC setup information.

In some aspects, such as illustrated in the example of FIG. 2, the UE 115-a may transmit a random access message 210, which may be a first or third RACH transmission of the four-step RACH procedure (e.g., a MSG1 or MSG3 transmission), or a RACH message of the two-step RACH procedure (e.g., a MSG A transmission), that indicates a request to connect with a NES cell associated with the NES network entity 105-b. The anchor network entity 105-a, based on the random access message 210, may transmit a random access response 225, which may indicate information related to the activation of the NES cell, which may be a second or fourth RACH transmission of the four-step RACH procedure (e.g., a MSG2 or MSG4 transmission), a second RACH message of the two-step RACH procedure (e.g., a MSG B transmission), or signaling subsequent to a RACH procedure (e.g., RRC signaling).

As discussed herein, for activation of a NES cell, in traditional systems the UE 115-a may perform initial access with an anchor cell (e.g., a serving cell associated with anchor network entity 105-a), which may be referred to as ‘cell-A,’ through synchronization with to cell-A and performing the initial connection setup (e.g., in accordance with a four-step or two-step RACH procedure). The anchor network entity 105-a may contact the core network (CN) to setup UE 115-a security context, and may establishes security with the UE 115-a via RRC signaling (e.g., an RRCReconfig message) over cell-A. In traditional systems, the anchor network entity 105-a may identify it is unlikely to be able to meet UE 115-a targets for communications, and may contact and activate NES cell(s), such as through exchange of security and UE 115-a information coordination signaling via one or more backhaul links 235. In some cases, the anchor network entity 105-a may configure measurements to be performed at the UE 115-a, and the UE 115-a may transmit one or more measurement reports to the anchor network entity 105-a. The anchor network entity 105-a may set up one or more radio bearers (e.g., a signaling radio bearer (SRB) and/or data radio bearer (DRB)) with the UE 115-a via RRC signaling (e.g., via a RRCReconfig msg over cell-A), and the anchor network entity 105-a may provide context and trust relationship information to the NES network entity 105-b via the one or more backhaul links 235. The anchor network entity 105-a may configure an NES cell with the UE 115-a via RRC signaling over cell-A, which may add or modify a SRB or DRB, or both, of the UE 115-a. The UE 115-a may then synchronize to the NES cell (e.g., in accordance with a RACH or RACH-less procedure) and start communicating with NES cell. As discussed, such procedures may result in some latency in the connection with the NES cell.

In accordance with some aspects, the anchor network entity 105-a may provide a random access configuration that provides for the UE 115-a to transmit an early indication of a request to connect with an idle or inactive cell, such as an NES cell associated with the NES network entity 105-b. In some aspects the UE 115-a may send an indication of a request to activate the idle or inactive NES cell in the random access message 210 to the anchor network entity 105-a (e.g., in MSG1 or MSG3, or MSG A), which may allow the activation of the inactive NES cell sooner than if the UE 115-a connection with cell-a had to be established prior to initiating activation of the NES cell. In some aspects, a signaling field may be added to the RACH message 210 to allow the UE 115-a to include one or more parameters associated with the request to activate the inactive NES cell. In some aspects, the UE 115-a may indicate one or more selected beams, a measurement report for one or more neighboring discoverable NES cells, or both, and the anchor network entity 105-a may provide an indication of suitable NES cell(s), assisting information associated with the identified NES cell(s), or both, in the random access response 225 or subsequent signaling (e.g., RRC signaling).

In some aspects, the anchor network entity 105-a, based on the received request from the UE 115-a, may initiate activation of the inactive NES cell(s), or give the inactive cell(s) an indication to prepare to admit a new UE. In some aspects, the anchor network entity 105-a may further complete the RACH procedure and establish a security context with the UE 115-a, and may transfer the security context to the activated cell. In some aspects, the anchor network entity 105-a may provide an indication to the UE 115-a of whether the request from the UE 115-a is accepted or rejected in the random access response 225 or in subsequent signaling (e.g., RRC signaling exchanged subsequent to completion of the RACH process).

Additionally, or alternatively, the anchor network entity 105-a may act as a relay for higher-layer signaling between the UE 115-a and the inactive NES cell. For example, the inactive cell may have idle RF components but have associated backhaul links 235 that are available for backhaul communications. In some aspects, the anchor network entity 105-a may provide PHY layer signaling, MAC layer signaling, or both, and relay higher layer communications between the UE 115-a and NES cell associated with the NES network entity 105-b via the backhaul links 235 until the NES cell can transition its RF components to an operational state and provide lower layer (e.g. PHY layer) signaling. In some aspects, the relayed communications may include RACH communications, and communications to establish a security context between the UE 115-a and the NES cell.

Such techniques may provide for reduced latency for communications with the NEC cell associated with the NES network entity 105-b via communications link 230. Such reduced latency may allow the UE 115-a to transmit more data with reduced latency than would be available using only the communications link 205, which may enhance user experience and enhance overall network throughput and efficiency while also providing that various cells may transition to NES power saving modes and reduce power consumption.

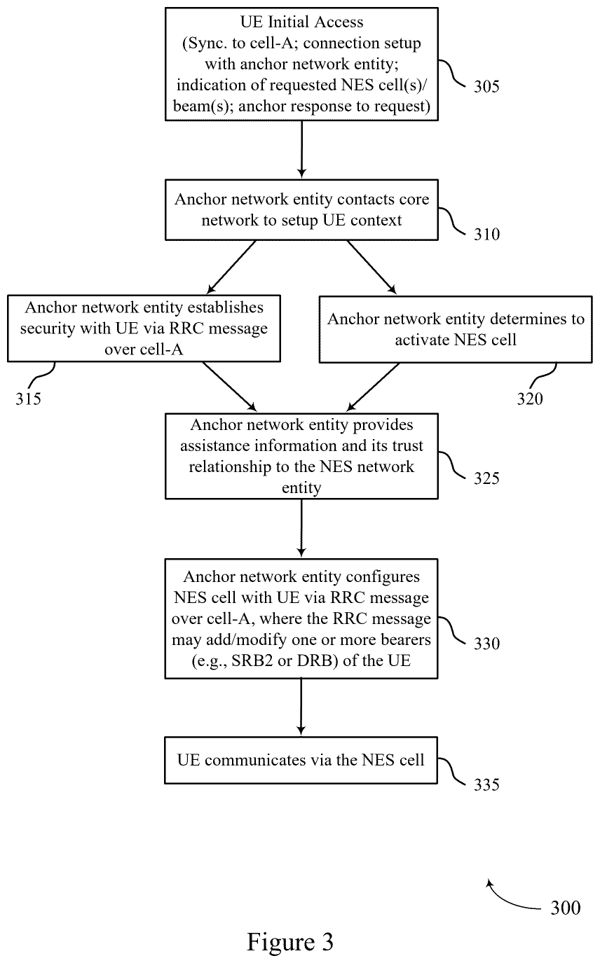

FIG. 3 shows an example of a flowchart 300 of a cell access scheme for network energy savings. Certain operations of the flowchart 300 may be implemented by a UE or its components as described herein (e.g., a UE 115 as described with reference to FIGS. 1 and 2), and other operations of the flowchart 300 may be implemented by a network entity or its components as described herein (e.g., a network entity 105 as described with reference to FIGS. 1 and 2). In some examples, a UE or network entity may execute a set of instructions to control the functional elements of the UE or network to perform the described functions. Additionally, or alternatively, the UE or network may perform aspects of the described functions using special-purpose hardware.

At 305, the UE may perform initial access. As discussed, such initial access may include a RACH procedure that is performed at an anchor cell, such as a four-step RACH procedure or a two-step RACH procedure. For example, the UE may synchronize to cell-A, and perform an initial connection setup (e.g., RACH procedure) with an anchor network entity via cell-A. The UE may also indicate one or more selected cells or beams of an inactive cell, such as a NES cell that is in an energy conservation mode. In some aspects, the anchor network entity may respond to the UE with an indication of one or more suitable cells (e.g., an NES cell).

In some aspects, during the RACH procedure, the UE may send an early indication to cell-A that may include, for example, one or more of an indication or request to connect to a list of one or multiple NES cells (or idle/inactive cells that may or may not be operating in accordance with NES techniques), one or more frequencies associated with the NES cells, one or more frequency ranges (FRs) associated with the NES cells, one or more frequency bands associated with the NES cells, a cell type (e.g., NTN/TN, mobile/stationary, small/macro-cell), or special features of the NES cells (e.g., NES, green/renewable-energy-sourced cells, etc.). In some aspects, the UE may provide a list of one or multiple detected/selected NES cells, possibly along with their associated beams (e.g., SSB indices), measured metrics (e.g., RSRP, RSRQ, SINR, etc.), or both. In some cases, the measured metrics may have been obtained by the UE while in an idle or inactive state. In some aspects, additionally, or alternatively, the indication from the UE may also provide an indication of capabilities of the UE (e.g., whether it supports 6G, certain FRs, or NES features). Additionally, or alternatively, the UE may provide an indication of a UE mobility state, which may enable the anchor network entity to determine which NES cells are suitable for the UE. As discussed herein, the request to connect to a NES cell may be provided via any combination of messages in a RACH procedure (e.g., MSG 1, MSG A, or MSG 3), or a later layer 1, layer 2, or layer 3 (L1/L2/L3) message, but prior to security establishment.

In some aspects, the anchor network entity may provide an indication of support for an early request to connect to a different cell. In some aspects, this indication may be provided in configuration information associated with the anchor network entity (e.g., via anchor cell system information). For example, the anchor network entity may provide information that indicates whether the UE can send such an indication and how the request is provided (e.g., resources and configuration), a list of cells or frequencies for which the UE can send the indication, one or more conditions for sending the indication (or selecting a cell as part of its indication). In some aspects, the conditions for sending the indication may be based on a cell selection or reselection framework, which may have a set of parameters that are associated with such requests.

In some aspects, the UE may be aware of the inactive cell based on measurements performed by the UE in an idle or inactive state, or from one or more previous connections to the cell. In some aspects, the UE may be allowed to store related information (e.g., used beam, obtained measurements, etc.) of NES cells to which it has been previously connected. In some aspects, the UE may store this information for a certain period of time, while the UE is within a certain region, or both. Such stored information may be beneficial to provide the anchor cell with relevant information for making a determination to activate the cell and switch the UE to the cell, and may be provided in cases where the inactive cell(s) are not discoverable.

In some aspects, the anchor network entity may receive the request from the UE and may attempt to establish the UE context (e.g., by contacting the core network) and security for the UE, and after which it may redirect the UE to another cell. However, the target cell may not be fully active or operational, and the anchor network entity may send an indication or request to a network entity associated with the target cell to request cell activation, beam activation, or both, or provide an early notification to prepare to admit a new UE. In some aspects, this may be performed any time after reception of the UE indication, such as after getting the UE context from the core network. In some cases, based on a level of activity of the other cell, the cell may take different amounts of time to get fully operational, and information related to this time may be shared between network entities and used for properly timing the backhaul indications. In some aspects, the anchor network entity response to the UE request may include providing assistance information to the network entity of the other cell, such as a UE reported beam for a NES cell, or a derived timing advance of the UE for the NES cell.

At 310, the anchor network entity may contact the core network to setup UE context. In some aspects, from the UE perspective and after going through the RACH procedure with the anchor cell, UE may to wait for UE context transfer (e.g., between the anchor network entity and the core network), and security establishment that may take some time (e.g., 10 s or 100 s of milliseconds). During this time, the UE does not have any data communication. In some aspects, if the UE is aware that it may or may not be transferred to another cell, it can use such information to better use its time. For example, if it will be transferred to another cell, the UE can use this time to do further measurements on the other cell, if available, and fine-tune its time, frequency, or beams, to enhance high-throughput communication as soon as it connects to the activated cell. In other cases, the UE may ignore other cell(s) and do more power saving. Thus, it may be beneficial to provide the UE with some early feedback about its request. In some aspects, the anchor network entity may send a response or indication to the UE, to notify the UE of a status of the request. For example, the UE may be indication of a rejection of the UE's request for connecting to the other or indicated cell(s), possibly along with a cause value (e.g., for energy savings, load balancing, not operational, etc.). In some examples, an absence of a rejection may implicitly mean that the network is preparing for the UE request. In other examples, an explicit indication may be provided that may indicate one or multiple other cells to which the UE connection and context may be transferred. In some aspects, the anchor network entity may provide the UE with measurement configuration or configuration of transmitted or activated reference signals on other cells, where the UE can perform further measurements. In some aspects, the anchor network entity may provide additional assistance information to facilitate the UE connection with the other cell (e.g., a time offset to start to synchronization with an NES cell or to start communication with the NES cell, a timing advance of UE with the NES cell, etc.). In some aspects, if the other cell is already active, the anchor network entity may inform UE to connect directly to cell. In some aspects, the UE may do a RACH-less transfer to the other cell to speed up the process.

At 315, the anchor network entity may establish security with the UE via RRC signaling, such as via a RRCReconfig message over cell-A. In this example, at 320, the anchor network entity may determine that throughput or latency targets associated with communications of the UE are not likely to be met by the anchor network entity, and the anchor network entity may activate an inactive cell, such as a NES cell. At 325, the anchor network entity may provide assistance information associated with the UE and its trust relationship to a network entity associated with the activated cell (e.g., a NES network entity associated with a NES cell).

At 330, the anchor network entity may configure the activated cell (e.g. NES cell) with the UE, such as via RRC signaling (e.g., an RRCReconfig message over cell-A). In some examples, the configuration may add or modify one or more of a SRB or DRB at the UE for communications with the activated cell. At 335, the UE may communicate via the activated cell in addition to, or in place of, communications via the anchor network entity.

In some examples, the UE may have one or more prior measurements associated with a requested NES cell, and may provide one or more selected beams, a measurement report neighboring discoverable NES cells, or both, with the request to connect with the NES cell. In such examples, the anchor network entity may respond back with suitable NES cell(s). In some aspects, the anchor network entity activation of the NES cell can be performed either when anchor network entity determines it may not be able to meet UE communications targets, immediately after the UE indication if anchor network entity is not able to provide services to the UE (e.g., in case of a shared radio access network), or delayed until the UE starts communication to save more energy.

In other examples, the UE may not have one or more prior measurements associated with a requested NES cell. In such examples, the UE may indicate its intention to connect to a NES cell, or the UE may indicate a capability for such connection. The anchor network entity may respond back with one or more suitable NES (e.g., 6G) cells while concurrently activating the one or more NES cells. After NES activation, the anchor network entity may configure measurements at the UE, and the UE may send a measurement report to the anchor network entity, which may be used to select a NES cell.

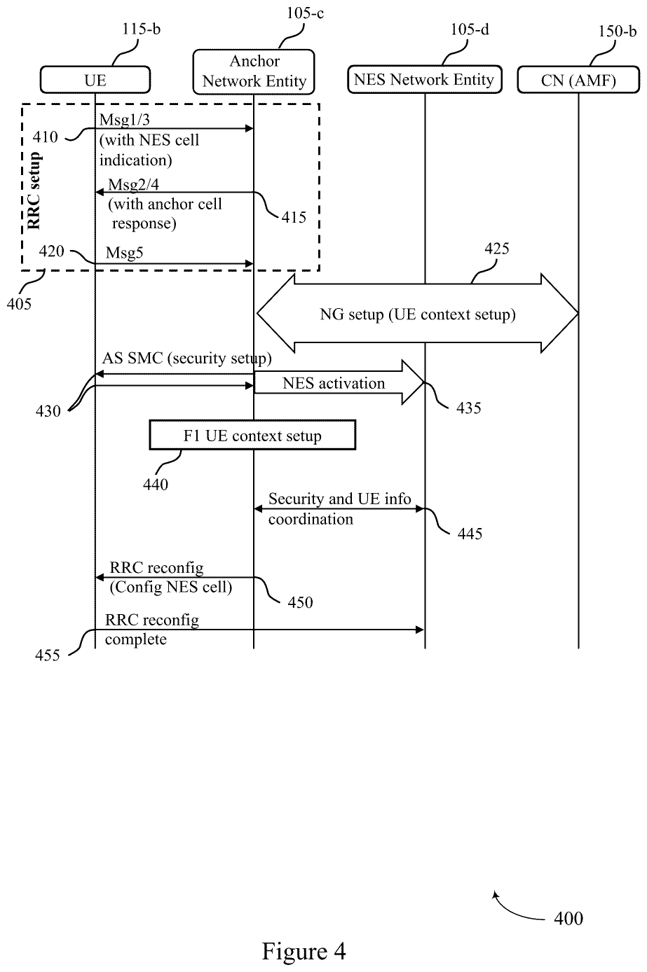

FIG. 4 shows an example of a process flow 400 that supports cell access schemes for network energy savings. In some examples, the process flow 400 may implement or be implemented by aspects of the wireless communications system 100 or signaling configuration 200, as described with reference to FIGS. 1 and 2, respectively. For example, the process flow 400 may be implemented by a UE 115-b, an anchor network entity 105-c, a NES network entity 105-d, and a core network 150-b (e.g., an access and mobility function (AMF)), which may be an example of the UEs 115, network entities 105, and core network 150, as described with reference to FIGS. 1 and 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the UE 115-b and the anchor network entity 105-c may perform an RRC setup. The RRC setup may be in accordance with a four-step RACH procedure, or a two-step RACH procedure, for example in which, at 410, a first random access message (e.g., MSG1, MSG3, or MSG A) may include an indication to connect to an NES cell. At 415, the anchor network entity 105-c may transmit a response message (e.g., MSG2, MSG4, or MSG B) that indicates a response to the request associated with the NES cell. In this example, at 420, the UE 115-b may transmit an RRC complete message (e.g., MSG5).

At 425, the anchor network entity 105-c and the core network 150-b may perform a context setup for the UE 115-c, in accordance with established context setup procedures. At 430, the anchor network entity 105-c and the UE 115-b may perform a security setup (e.g., an access stratum (AS) security setup). At 435 the anchor network entity 105-c may transmit an NES activation indication to the NES network entity 105-d. At 440, the anchor network entity 105-c may complete the UE context setup, and at 445 the anchor network entity 105-c and the NES network entity 105-d may exchange signaling for security and UE information for coordination of communications between the UE 115-b and the NES network entity 105-d.

At 450, the anchor network entity 105-c may transmit, and the UE 115-b may receive, RRC configuration information that configures the NES network entity 105-d at the UE 115-b. At 455, the UE 115-b may transmit, and the NES network entity 105-d may receive, an RRC configuration complete message. The UE 115-b and the NES network entity 105-d may then exchange communications, which may include control and data communications. In accordance with the early indication of the request to connect with the NES network entity 105-d, the anchor network entity 105-c may initiate activation of the NES network entity 105-d prior to competing context and security setup for the UE 115-b, which may reduce latency for the data that is transmitted via the NES network entity 105-d.

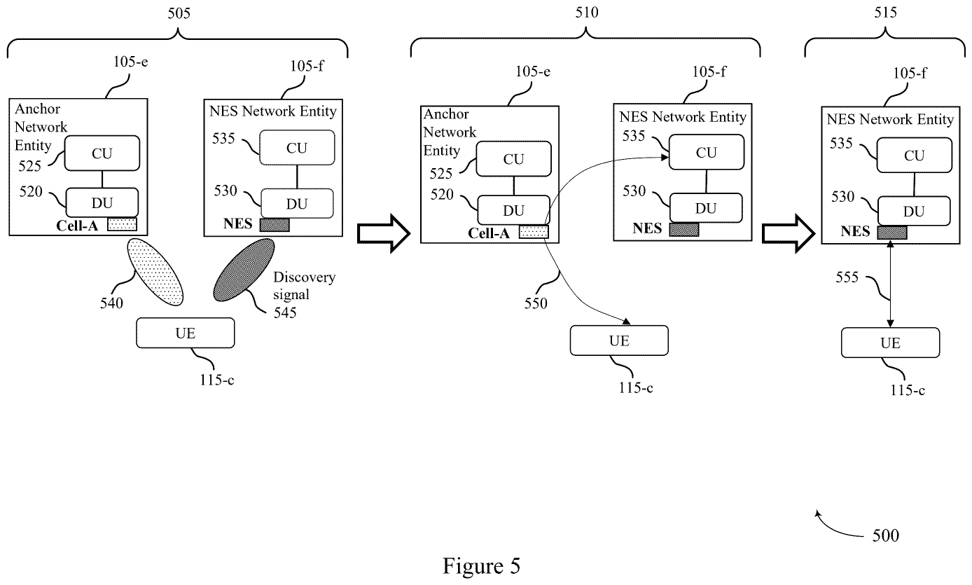

FIG. 5 shows an example of a relay scheme 500 that supports cell access schemes for network energy savings. The relay scheme 500 may implement aspects of or may be implemented by aspects of the wireless communications system 100, or signaling configuration 200, as described with reference to FIGS. 1 and 2, respectively. For example, the relay scheme 500 includes a UE 115-c, which may be an example of a UE 115 as described herein. The relay scheme 500 may also include an anchor network entity 105-e and a NES network entity 105-f, which may be examples of network entities 105 as described herein. In some aspects, cell-A may be associated with the anchor network entity 105-e and a NES cell may be associated with the NES network entity 105-f. The anchor network entity 105-e may have an associated DU 520 and an associated CU 525, and the NES network entity 105-f may have an associated DU 530 and an associated CU 535.

In the example of FIG. 5, at a first time instance 505 the UE 115-c may communicate with the anchor network entity 105-e via a beam 540, and may identify the NES network entity 105-f based on a discovery signal 545 of the NES network entity 105-f. In some aspects, the UE 115-c may be in an idle mode and may transmit an access request to the anchor network entity 105-e via beam 540, which may include a request to connect with the NES network entity 105-f. In some examples, the anchor network entity 105-e may identify that the CU 535 of the NES network entity 105-f is active and available for communications via a backhaul link, and that the DU 530 associated with the NES cell of the NES network entity 105-f is in a lower power state with RF components powered down, for example. Based on such a determination, the anchor network entity 105-e may initiate relayed communications between the UE 115-c and the CU 535 of the NES network entity 105-f.

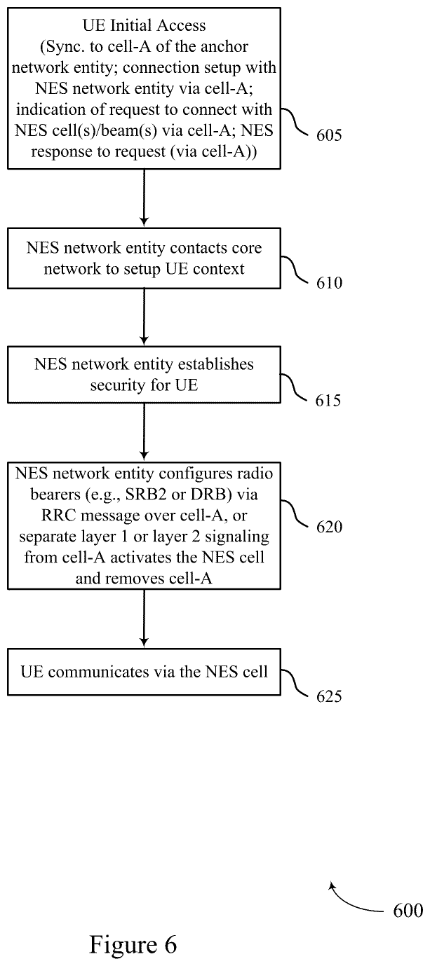

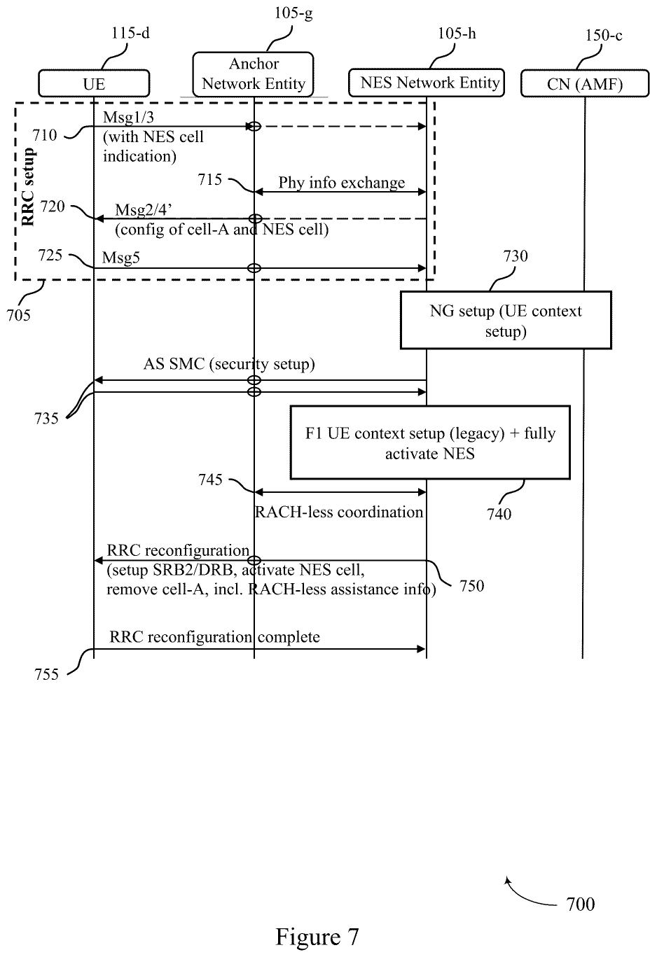

At a second time instance 510, the anchor network entity 105-e may establish a relayed communication link 550 between the UE 115-c and the NES network entity 105-f. The relayed communication link 550 may be used until the NES network entity 105-f powers on the DU 520 at a third time instance 515, and provides communications via link 555 with the UE 115-c. Thus, instead of first establishing the lower layers (PHY/MAC), and then upper-layers (RRC and above), the UE 115-c may follow a top-down establishment of a connection to the NES network entity 105-f. That is, the UE 115-c connects to the CU 535 of the NES network entity 105-f (e.g. via cell-A), and then while the NES cell stops energy saving and its lower-layer/RF becomes operational, then UE 115-c connects the lower layers to the NES cell of the NES network entity 105-f. FIGS. 6 and 7 discuss some examples of such relayed communications associated with an anchor network entity 105-e and NES network entity 105-f.

FIG. 6 shows an example of a flowchart 600 that supports cell access schemes for network energy savings. Certain operations of the flowchart 600 may be implemented by a UE or its components as described herein (e.g., a UE 115 as described with reference to FIGS. 1 through 5), and other operations of the flowchart 600 may be implemented by a network entity or its components as described herein (e.g., a network entity 105 as described with reference to FIGS. 1 through 5). In some examples, a UE or network entity may execute a set of instructions to control the functional elements of the UE or network to perform the described functions. Additionally, or alternatively, the UE or network may perform aspects of the described functions using special-purpose hardware.

At 605, the UE may perform initial access. In some aspects, such initial access may include synchronization to cell-A of the anchor network entity, and a random access procedure for connection setup with a NES network entity via relayed communications with cell-A. In some aspects, a random access request from the UE to cell-A may include an indication of a request to connect with one or more NES cells or beams via cell-A, which may allow the anchor network entity to relay the request (e.g., RACH request) to the NES network entity, along with subsequent RACH messages. The NES network entity (e.g., CU at the NES network entity) may provide a response to the request (via cell-A).

At 610, the NES network entity may contact the core network to setup UE context. Such operations may be initiated based on receipt of a request from the UE that is relayed to the NES network entity via cell A and the anchor network entity via a backhaul link, as discussed herein. At 615, the NES network entity may establish security for the UE using relayed communications via cell-A of the anchor network entity.

At 620, the NES network entity may configure radio bearers (e.g., SRB, DRB, or both) via RRC messages over cell-A. In some aspects, separate layer 1 or layer 2 signaling from cell-A may activate the NES cell to allow for direct communications between the UE and the NES cell, and remove cell-A. At 625, the UE may communicate directly via the NES cell.

FIG. 7 shows an example of a process flow 700 that supports cell access schemes for network energy savings. In some examples, the process flow 700 may implement or be implemented by aspects of the wireless communications system 100 or signaling configuration 200, as described with reference to FIGS. 1 and 2, respectively. For example, the process flow 700 may be implemented by a UE 115-d, an anchor network entity 105-g, a NES network entity 105-h, and a core network 150-c (e.g., an access and mobility function (AMF)), which may be an example of the UEs 115, network entities 105, and core network 150, as described with reference to FIGS. 1 and 2.

In some examples, the operations illustrated in process flow 700 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 705, the UE 115-b and the NES network entity 105-h may perform an RRC setup via anchor network entity 105-g. The RRC setup may be in accordance with a four-step RACH procedure, or a two-step RACH procedure, for example in which, at 710, a first random access message (e.g., MSG1, MSG3, or MSG A) may include an indication to connect to an NES cell, which may be received at the anchor network entity 105-g and relayed to the NES network entity 105-h. At 715, the anchor network entity 105-g and the NES network entity 105-h may exchange physical layer information related to a connection establishment with the NES network entity 105-h. At 720, the NES network entity 105-h may transmit a response message (e.g., a MSG2 or modified MSG4 message, or a MSG B message) via the anchor network entity 105-g to the UE 115-d that indicates a response to the request associated with the NES cell. In some aspects, a modified MSG4 (e.g., MSG4′) may be provided by the NES network entity 105-h via cell-A, which may indicate a connection setup for SRB0 and configuration of the NES cell, with an indication that the NES cell is in a deactivated state. In this example, at 725, the UE 115-b may transmit an RRC complete message (e.g., MSG5) to the NES network entity 105-h via the anchor network entity 105-g.

At 730, the NES network entity 105-h and the core network 150-c may perform UE context setup, in accordance with established context setup procedures. At 735, the NES network entity 105-h and the UE 115-d may perform a security setup between via the anchor network entity 105-g. At 740, the NES network entity 105-h may complete the UE context setup. At 745 the anchor network entity 105-g and the NES network entity 105-h may exchange signaling for RACH-less coordination of communications between the UE 115-d and the NES network entity 105-h.

At 750, the NES network entity 105-h may transmit, via the anchor network entity 105-g, an RRC reconfiguration message to the UE 115-d, that may setup a SRB, DRB, or both. Further, the RRC reconfiguration message may activate the NES cell and remove cell-A in the same RRC reconfiguration message, or by a separate L1/L2 signaling via cell-A. At 755, the UE 115-d may transmit an RRC reconfiguration complete message to the NES network entity 105-h directly. The UE 115-d and NES network entity 105-h may perform subsequent communications. Such techniques may help to reduce signaling overhead between the anchor network entity 105-g and the NES network entity 105-h, by allowing the NES network entity 105-h to perform UE context and security setups, while also providing for reduced latency in setting up the connection between the UE 115-d and the NES network entity 105-h.

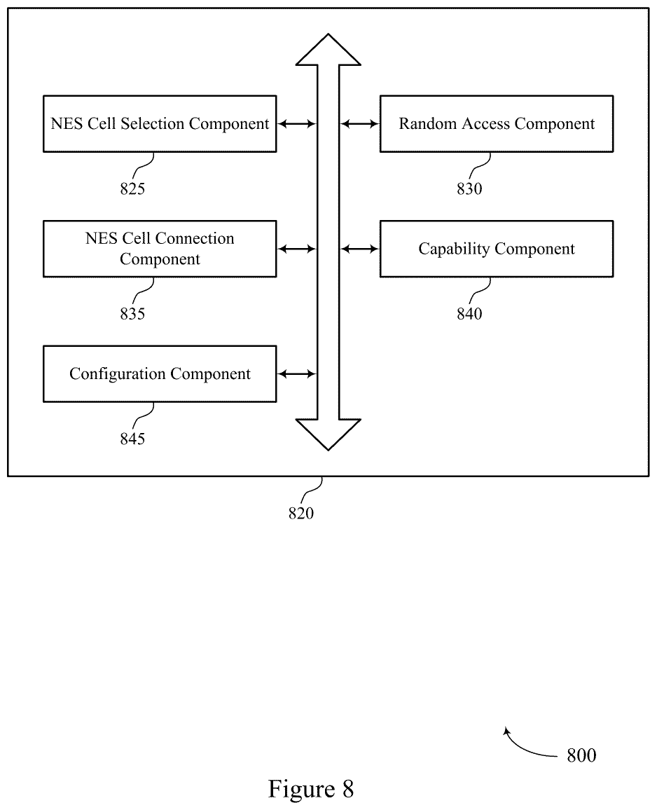

FIG. 8 shows an example of a processing system 820 that supports cell access schemes for network energy savings. A processing system 820 may be an example of a processing system 140 (such as of a UE 115) and may include a NES cell selection component 825, a random access component 830, a NES cell connection component 835, a capability component 840, a configuration component 845, or any combination thereof. A processing system 820, or various component thereof, may be an example of means for performing (such as a means for causing a UE 115 to perform) various techniques described herein.

The NES cell selection component 825 may be configured to cause the UE 115 to transmit a random access message to a first cell, where the random access message includes a request to establish a connection with a second cell that is different than the first cell, where the second cell is unavailable for a random access procedure. The random access component 830 may be configured to cause the UE 115 to receive a response message from the first cell that indicates an availability of the second cell for the connection with the UE. The NES cell connection component 835 may be configured to cause the UE 115 to establish, subsequent to reception of the response message, the connection with the second cell.

In some examples, the random access message indicates one or more of a selected beam or a measurement report parameter associated with the second cell, the selected beam or the measurement report parameter based on a prior measurement of the second cell performed at the UE. In some examples, the response message from the first cell is a random access response that provides information for establishment of the connection with the second cell. In some examples, the request to establish the connection with the second cell indicates one or more of a cell ID of the second cell, a beam ID of one or more beams associated with the second cell, cell frequency information associated with the second cell, or a cell type of the second cell. In some examples, the cell frequency information associated with the second cell includes one or more of an operating frequency, a frequency range, or one or more frequency bands of the second cell. In some examples, the cell type of the second cell indicates one or more of a non-terrestrial network cell, a terrestrial network cell, a mobile cell, a stationary cell, a small cell, a macro cell, or a cell feature of the second cell. In some examples, the request to establish the connection with the second cell is transmitted in a first random access message or a third random access message of a four-step random access procedure, or in an initial random access message of a two-step random access procedure. In some examples, the request to establish the connection with the second cell indicates one or more capabilities of the UE associated with one or more characteristics of the second cell, the one or more capabilities including one or more of a radio access technology communications capability (e.g., a 5G or 6G communications capability), one or more supported frequency ranges of the UE, or one or more supported network energy savings features.

In some examples, the configuration component 845 may be configured to cause the UE 115 to receive, from the first cell prior to transmission of the request to establish the connection with the second cell, configuration information associated with a random access procedure, where the configuration information indicates the request to establish the connection with the second cell is able to be transmitted in a first random access message or a third random access message of a four-step random access procedure, or in an initial random access message of a two-step random access procedure. In some examples, the configuration information indicates a list of cells or frequencies for which the UE can send the request, one or more criteria to be satisfied prior to transmission of the request, or any combination thereof.

In some examples, the NES cell selection component 825 may be configured to cause the UE 115 to identify the second cell based on one or more measurements associated with the second cell that are stored at the UE, or based on a prior connection between the UE and the second cell. In some examples, the NES cell connection component 835 may be configured to cause the UE 115 to perform one or more of a measurement procedure associated with the second cell, or a tuning procedure for one or more radio frequency components of the UE for communication with the second cell, based on the response message. In some examples, the response message indicates an acceptance or a rejection of the request to establish the connection with the second cell.

In some examples, the configuration component 845 may be configured to cause the UE 115 to receive, from the first cell, configuration information associated with the second cell that indicates one or more of a measurement configuration associated with the second cell, a reference signal configuration associated with the second cell, or timing information associated with the second cell. In some examples, the response message indicates the first cell will relay communications between the UE and the second cell until the connection between the UE and the second cell is established. In some examples, the NES cell connection component 835 may be configured to cause the UE 115 to establish a security context with the second cell in accordance with communications between the UE and the second cell that are relayed via the first cell. In some examples, the response message is received from the second cell via the first cell. In some examples, the response message provides configuration information for the second cell and indicates the second cell is in a deactivated state, and where a subsequent radio resource control configuration message indicates the second cell is activated. In some examples, the second cell is a NES cell and the first cell is an anchor cell, where a cell coverage area of the anchor cell overlaps at least in part with a cell coverage area of the NES cell.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for providing a request to access an inactive cell in a random access procedure, which may reduce latency for activating an inactive cell and provide communications resources of the inactive cell which may enhance data rates and reduce communications latency for a UE.

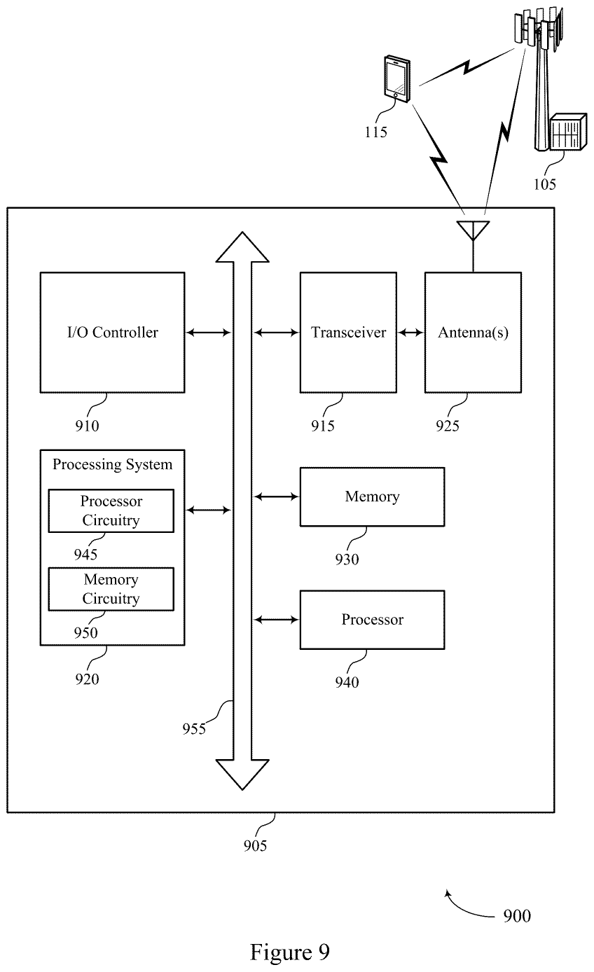

FIG. 9 shows an example of a system 900 including a device 905 that supports cell access schemes for network energy savings. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 800. For example, the processing system 920 may include processor circuitry 945 and memory circuitry 950 that stores code, and may be configured to cause the device 905 to perform operations that support cell access schemes for network energy savings. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for providing a request to access an inactive cell in a random access procedure, which may reduce latency for activating an inactive cell and provide communications resources of the inactive cell which may enhance data rates and reduce communications latency for a UE

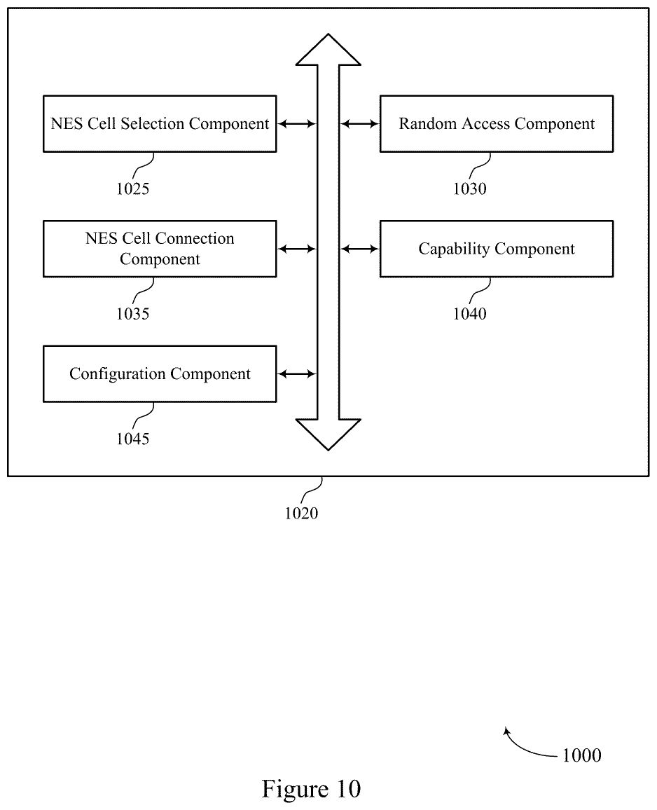

FIG. 10 shows an example of a processing system 1020 that supports cell access schemes for network energy savings. A processing system 1020 may be an example of a processing system 145 (such as network entity 105) and may include a NES cell selection component 1025, a random access component 1030, a NES cell connection component 1035, a capability component 1040, a configuration component 1045, or any combination thereof. A processing system 1020, or various component thereof, may be an example of means for performing (such as a means for causing a network entity 105 to perform) various techniques described herein.

The NES cell selection component 1025 may be configured to cause the network entity 105 to receive, from a UE, a random access message that includes a request to establish a connection with a second cell that is different than the first cell, where the second cell is unavailable for a random access procedure. The random access component 1030 may be configured to cause the network entity 105 to transmit, to the UE, a response message that indicates an availability of the second cell for the connection with the UE. The NES cell connection component 1035 may be configured to cause the network entity 105 to transmit one or more messages to the second cell to initiate establishment of the connection between the second cell and the UE.

In some examples, the random access message indicates one or more of a selected beam or a measurement report parameter associated with the second cell, the selected beam or the measurement report parameter based on a prior measurement of the second cell performed at the UE. In some examples, the response message is a random access response that provides information for establishment of the connection between the UE and the second cell. In some examples, the request to establish the connection with the second cell indicates one or more of a cell ID of the second cell, a beam ID of one or more beams associated with the second cell, cell frequency information associated with the second cell, or a cell type of the second cell. In some examples, the cell frequency information associated with the second cell includes one or more of an operating frequency, a frequency range, or one or more frequency bands of the second cell. In some examples, the cell type of the second cell indicates one or more of a non-terrestrial network cell, a terrestrial network cell, a mobile cell, a stationary cell, a small cell, a macro cell, or a cell feature of the second cell. In some examples, the request to establish the connection with the second cell is received in a first random access message or a third random access message of a four-step random access procedure, or in an initial random access message of a two-step random access procedure. In some examples, the request to establish the connection with the second cell indicates one or more capabilities of the UE associated with one or more characteristics of the second cell, the one or more capabilities including one or more of a sixth-generation (6G) communications capability, one or more supported frequency ranges of the UE, or one or more supported network energy savings features.

In some examples, the configuration component 1045 may be configured to cause the network entity 105 to transmit, prior to reception of the request to establish the connection with the second cell, configuration information associated with a random access procedure of the first cell, where the configuration information indicates the request to establish the connection with the second cell is able to be transmitted in a first random access message or a third random access message of a four-step random access procedure, or in an initial random access message of a two-step random access procedure. In some examples, the configuration information indicates a list of cells or frequencies for which the UE can send the request, one or more criteria to be satisfied prior to transmission of the request, or any combination thereof. In some examples, the configuration information indicates that the UE can select the second cell based on one or more measurements associated with the second cell that are stored at the UE, or based on a prior connection between the UE and the second cell. In some examples, the NES cell connection component 1035 may be configured to cause the network entity 105 to transmit, to the second cell, one or more of an activation request, early notification to prepare to admit the UE, an indication of a reported beam associated with the UE, a derived timing advance of the UE for the second cell, or any combination thereof. In some examples, the response message indicates an acceptance or a rejection of the request to establish the connection with the second cell.

In some examples, the configuration component 1045 may be configured to cause the network entity 105 to transmit, to the UE, configuration information associated with the second cell that indicates one or more of a measurement configuration associated with the second cell, a reference signal configuration associated with the second cell, or timing information associated with the second cell. In some examples, the response message indicates the first cell will relay communications between the UE and the second cell until the connection between the UE and the second cell is established. In some examples, the second cell establishes a security context with the UE in accordance with communications between the UE and the second cell that are relayed via the first cell. In some examples, the NES cell connection component 1035 may be configured to cause the network entity 105 to transmit, to the second cell, the request to establish the connection between the UE and the second cell. In some examples, the NES cell connection component 1035 may be configured to cause the network entity 105 to relay a response message that is received from the second cell to the UE.

In some examples, the response message provides configuration information for the second cell and indicates the second cell is in a deactivated state, and where a subsequent radio resource control configuration message indicates the second cell is activated. In some examples, the second cell is a NES cell and the first cell is an anchor cell, where a cell coverage area of the anchor cell overlaps at least in part with a cell coverage area of the NES cell.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for providing a request to access an inactive cell in a random access procedure, which may reduce latency for activating an inactive cell and provide communications resources of the inactive cell which may enhance data rates and reduce communications latency for a UE.

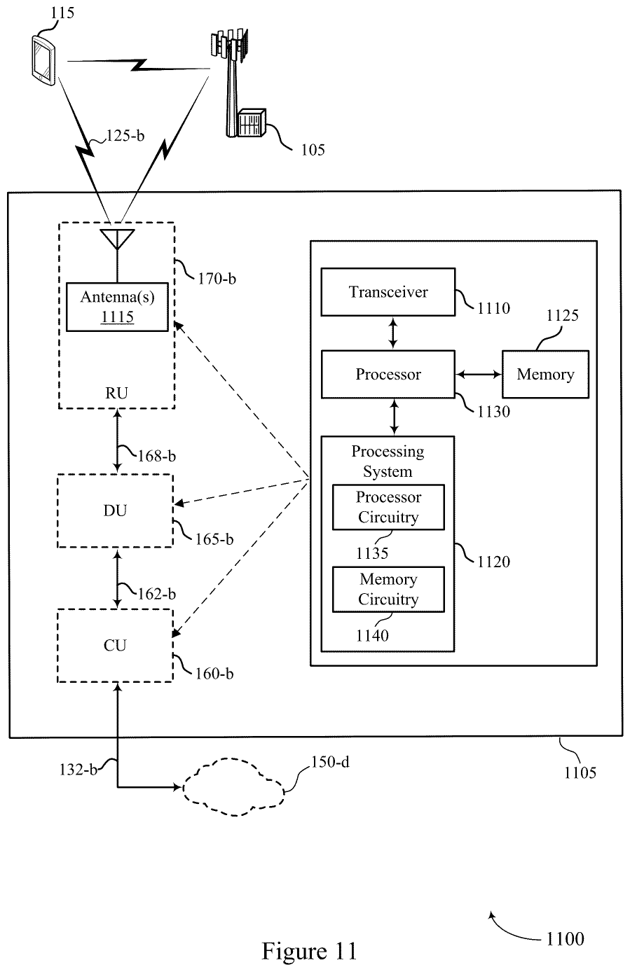

FIG. 11 shows an example of a system 1100 including a device 1105 that supports cell access schemes for network energy savings. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-d (such as via a backhaul link 132). For example, the processing system 1120 may manage the transfer of data communication for UEs 115 with a gateway of the core network 150-d. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1000. For example, the processing system 1120 may include processor circuitry 1135 and memory circuitry 1140 that stores code, and the processing system 1120 may be configured to cause the device 1105 to perform operations that support cell access schemes for network energy savings. Although the processing system 1120 is illustrated as a separate component, which may involve a separate chip, chipset, or other module, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for providing a request to access an inactive cell in a random access procedure, which may reduce latency for activating an inactive cell and provide communications resources of the inactive cell which may enhance data rates and reduce communications latency for a UE.

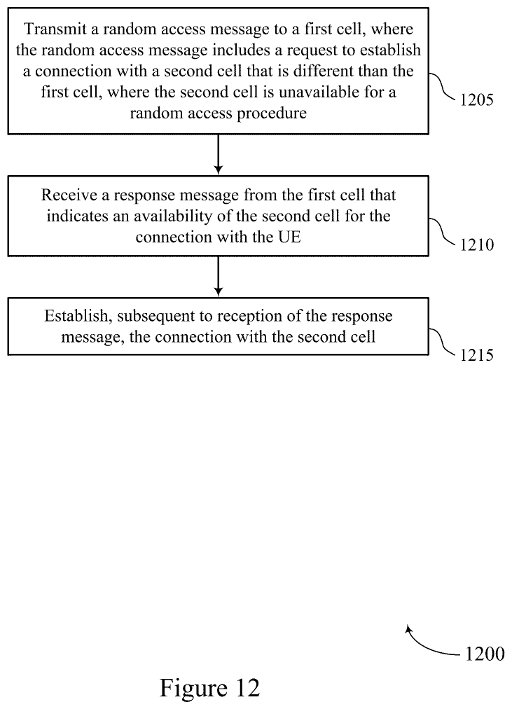

FIG. 12 shows an example of a method 1200 that supports cell access schemes for network energy savings. Operations of the method 1200 may be performed by a UE or its components (such as using a processing system configured to cause the UE 115 to perform one or more of the operations) as described herein.

At 1205, the method may include transmitting a random access message to a first cell, where the random access message includes a request to establish a connection with a second cell that is different than the first cell, where the second cell is unavailable for a random access procedure. In some examples, aspects of the operations of 1205 may be performed by a NES cell selection component 825.

At 1210, the method may include receiving a response message from the first cell that indicates an availability of the second cell for the connection with the UE. In some examples, aspects of the operations of 1210 may be performed by a random access component 830.

At 1215, the method may include establishing, subsequent to reception of the response message, the connection with the second cell. In some examples, aspects of the operations of 1215 may be performed by a NES cell connection component 835.

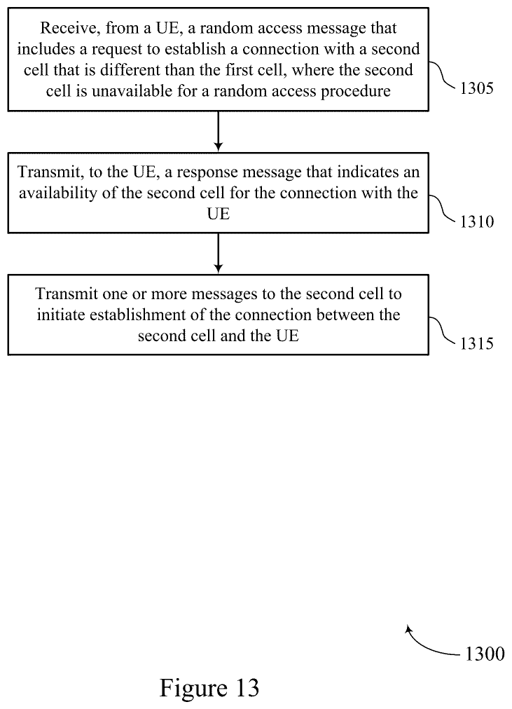

FIG. 13 shows an example of a method 1300 that supports cell access schemes for network energy savings. Operations of the method 1300 may be performed by a network entity 105 or its components (such as using a processing system configured to cause the network entity to perform one or more operations) as described herein.

At 1305, the method may include receiving, from a UE, a random access message that includes a request to establish a connection with a second cell that is different than the first cell, where the second cell is unavailable for a random access procedure. In some examples, aspects of the operations of 1305 may be performed by a NES cell selection component 1025.

At 1310, the method may include transmitting, to the UE, a response message that indicates an availability of the second cell for the connection with the UE. In some examples, aspects of the operations of 1310 may be performed by a random access component 1030.

At 1315, the method may include transmitting one or more messages to the second cell to initiate establishment of the connection between the second cell and the UE. In some examples, aspects of the operations of 1315 may be performed by a NES cell connection component 1035.

Aspect 1: A method for wireless communications at a UE, comprising: transmitting a random access message to a first cell, wherein the random access message includes a request to establish a connection with a second cell that is different than the first cell, wherein the second cell is unavailable for a random access procedure; receiving a response message from the first cell that indicates an availability of the second cell for the connection with the UE; and establishing, subsequent to reception of the response message, the connection with the second cell.

Aspect 2: The method of aspect 1, wherein the random access message indicates one or more of a selected beam or a measurement report parameter associated with the second cell, the selected beam or the measurement report parameter based at least in part on a prior measurement of the second cell performed at the UE.

Aspect 3: The method of any of aspects 1 through 2, wherein the response message from the first cell is a random access response that provides information for establishment of the connection with the second cell.

Aspect 4: The method of any of aspects 1 through 3, wherein the request to establish the connection with the second cell indicates one or more of a cell ID of the second cell, a beam ID of one or more beams associated with the second cell, cell frequency information associated with the second cell, or a cell type of the second cell.

Aspect 5: The method of aspect 4, wherein the cell frequency information associated with the second cell includes one or more of an operating frequency, a frequency range, or one or more frequency bands of the second cell, and the cell type of the second cell indicates one or more of a non-terrestrial network cell, a terrestrial network cell, a mobile cell, a stationary cell, a small cell, a macro cell, or a cell feature of the second cell.

Aspect 6: The method of any of aspects 1 through 5, wherein the request to establish the connection with the second cell is transmitted in a first random access message or a third random access message of a four-step random access procedure, or in an initial random access message of a two-step random access procedure.

Aspect 7: The method of any of aspects 1 through 6, wherein the request to establish the connection with the second cell indicates one or more capabilities of the UE associated with one or more characteristics of the second cell, the one or more capabilities including one or more of a radio access technology communications capability, one or more supported frequency ranges of the UE, or one or more supported network energy savings features.

Aspect 8: The method of any of aspects 1 through 7, further comprising: receiving, from the first cell prior to transmission of the request to establish the connection with the second cell, configuration information associated with a random access procedure, wherein the configuration information indicates the request to establish the connection with the second cell is able to be transmitted in a first random access message or a third random access message of a four-step random access procedure, or in an initial random access message of a two-step random access procedure.

Aspect 9: The method of aspect 8, wherein the configuration information indicates a list of cells or frequencies for which the UE can send the request, one or more criteria to be satisfied prior to transmission of the request, or any combination thereof.

Aspect 10: The method of any of aspects 1 through 9, further comprising: identifying the second cell based at least in part on one or more measurements associated with the second cell that are stored at the UE, or based at least in part on a prior connection between the UE and the second cell.

Aspect 11: The method of any of aspects 1 through 10, further comprising: performing one or more of a measurement procedure associated with the second cell, or a tuning procedure for one or more radio frequency components of the UE for communication with the second cell, based at least in part on the response message.

Aspect 12: The method of any of aspects 1 through 11, wherein the response message indicates an acceptance or a rejection of the request to establish the connection with the second cell.

Aspect 13: The method of any of aspects 1 through 12, further comprising: receiving, from the first cell, configuration information associated with the second cell that indicates one or more of a measurement configuration associated with the second cell, a reference signal configuration associated with the second cell, or timing information associated with the second cell.

Aspect 14: The method of any of aspects 1 through 13, wherein the response message indicates the first cell will relay communications between the UE and the second cell until the connection between the UE and the second cell is established.

Aspect 15: The method of aspect 14, further comprising: establishing a security context with the second cell in accordance with communications between the UE and the second cell that are relayed via the first cell.

Aspect 16: The method of any of aspects 14 through 15, wherein the response message is received from the second cell via the first cell.

Aspect 17: The method of any of aspects 14 through 16, wherein the response message provides configuration information for the second cell and indicates the second cell is in a deactivated state, and wherein a subsequent radio resource control configuration message indicates the second cell is activated.

Aspect 18: The method of any of aspects 1 through 17, wherein the second cell is a network energy saving (NES) cell and the first cell is an anchor cell, wherein a cell coverage area of the anchor cell overlaps at least in part with a cell coverage area of the NES cell.

Aspect 19: A method for wireless communications at a first cell, comprising: receiving, from a UE, a random access message that includes a request to establish a connection with a second cell that is different than the first cell, wherein the second cell is unavailable for a random access procedure; transmitting, to the UE, a response message that indicates an availability of the second cell for the connection with the UE; and transmitting one or more messages to the second cell to initiate establishment of the connection between the second cell and the UE.

Aspect 20: The method of aspect 19, wherein the random access message indicates one or more of a selected beam or a measurement report parameter associated with the second cell, the selected beam or the measurement report parameter based at least in part on a prior measurement of the second cell performed at the UE.

Aspect 21: The method of any of aspects 19 through 20, wherein the response message is a random access response that provides information for establishment of the connection between the UE and the second cell.

Aspect 22: The method of any of aspects 19 through 21, wherein the request to establish the connection with the second cell indicates one or more of a cell ID of the second cell, a beam ID of one or more beams associated with the second cell, cell frequency information associated with the second cell, or a cell type of the second cell.

Aspect 23: The method of aspect 22, wherein the cell frequency information associated with the second cell includes one or more of an operating frequency, a frequency range, or one or more frequency bands of the second cell, and the cell type of the second cell indicates one or more of a non-terrestrial network cell, a terrestrial network cell, a mobile cell, a stationary cell, a small cell, a macro cell, or a cell feature of the second cell.

Aspect 24: The method of any of aspects 19 through 23, wherein the request to establish the connection with the second cell is received in a first random access message or a third random access message of a four-step random access procedure, or in an initial random access message of a two-step random access procedure.

Aspect 25: The method of any of aspects 19 through 24, wherein the request to establish the connection with the second cell indicates one or more capabilities of the UE associated with one or more characteristics of the second cell, the one or more capabilities including one or more of a sixth-generation (6G) communications capability, one or more supported frequency ranges of the UE, or one or more supported network energy savings features.

Aspect 26: The method of any of aspects 19 through 25, further comprising: transmitting, prior to reception of the request to establish the connection with the second cell, configuration information associated with a random access procedure of the first cell, wherein the configuration information indicates the request to establish the connection with the second cell is able to be transmitted in a first random access message or a third random access message of a four-step random access procedure, or in an initial random access message of a two-step random access procedure.

Aspect 27: The method of aspect 26, wherein the configuration information indicates a list of cells or frequencies for which the UE can send the request, one or more criteria to be satisfied prior to transmission of the request, or any combination thereof.

Aspect 28: The method of any of aspects 26 through 27, wherein the configuration information indicates that the UE can select the second cell based at least in part on one or more measurements associated with the second cell that are stored at the UE, or based at least in part on a prior connection between the UE and the second cell.

Aspect 29: The method of any of aspects 19 through 28, further comprising: transmitting, to the second cell, one or more of an activation request, early notification to prepare to admit the UE, an indication of a reported beam associated with the UE, a derived timing advance of the UE for the second cell, or any combination thereof.

Aspect 30: The method of any of aspects 19 through 29, wherein the response message indicates an acceptance or a rejection of the request to establish the connection with the second cell.

Aspect 31: The method of any of aspects 19 through 30, further comprising: transmitting, to the UE, configuration information associated with the second cell that indicates one or more of a measurement configuration associated with the second cell, a reference signal configuration associated with the second cell, or timing information associated with the second cell.

Aspect 32: The method of any of aspects 19 through 31, wherein the response message indicates the first cell will relay communications between the UE and the second cell until the connection between the UE and the second cell is established.

Aspect 33: The method of aspect 32, wherein the second cell establishes a security context with the UE in accordance with communications between the UE and the second cell that are relayed via the first cell.

Aspect 34: The method of any of aspects 32 through 33, further comprising: transmitting, to the second cell, the request to establish the connection between the UE and the second cell; and relaying a response message that is received from the second cell to the UE.

Aspect 35: The method of any of aspects 32 through 34, wherein the response message provides configuration information for the second cell and indicates the second cell is in a deactivated state, and wherein a subsequent radio resource control configuration message indicates the second cell is activated.

Aspect 36: The method of any of aspects 19 through 35, wherein the second cell is a network energy saving (NES) cell and the first cell is an anchor cell, wherein a cell coverage area of the anchor cell overlaps at least in part with a cell coverage area of the NES cell.

Aspect 37: A UE for wireless communications, comprising a processing system that includes processor circuitry and memory circuitry that stores code, the processing system configured to cause the UE to perform a method of any of aspects 1 through 18.

Aspect 38: A UE for wireless communications, comprising at least one means for performing a method of any of aspects 1 through 18.

Aspect 39: A non-transitory computer-readable medium storing code for wireless communications, the code comprising instructions executable by one or more processors to perform a method of any of aspects 1 through 18.

Aspect 40: A first cell for wireless communications, comprising a processing system that includes processor circuitry and memory circuitry that stores code, the processing system configured to cause the first cell to perform a method of any of aspects 19 through 36.

Aspect 41: A first cell for wireless communications, comprising at least one means for performing a method of any of aspects 19 through 36.

Aspect 42: A non-transitory computer-readable medium storing code for wireless communications, the code comprising instructions executable by one or more processors to perform a method of any of aspects 19 through 36.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
transmit a random access message to a first cell, wherein the random access message includes a request to establish a connection with a second cell that is different than the first cell, wherein the second cell is unavailable for a random access procedure;
receive a response message from the first cell that indicates an availability of the second cell for the connection with the UE; and
establish, subsequent to reception of the response message, the connection with the second cell.

2. The UE of claim 1, wherein the random access message indicates one or more of a selected beam or a measurement report parameter associated with the second cell, the selected beam or the measurement report parameter based at least in part on a prior measurement of the second cell performed at the UE.

3. The UE of claim 1, wherein the response message from the first cell is a random access response that provides information for establishment of the connection with the second cell.

4. The UE of claim 1, wherein the request to establish the connection with the second cell indicates one or more of a cell ID of the second cell, a beam ID of one or more beams associated with the second cell, cell frequency information associated with the second cell, or a cell type of the second cell.

5. The UE of claim 4, wherein:
the cell frequency information associated with the second cell includes one or more of an operating frequency, a frequency range, or one or more frequency bands of the second cell, and
the cell type of the second cell indicates one or more of a non-terrestrial network cell, a terrestrial network cell, a mobile cell, a stationary cell, a small cell, a macro cell, or a cell feature of the second cell.

6. The UE of claim 1, wherein the request to establish the connection with the second cell is transmitted in a first random access message or a third random access message of a four-step random access procedure, or in an initial random access message of a two-step random access procedure.

7. The UE of claim 1, wherein the request to establish the connection with the second cell indicates one or more capabilities of the UE associated with one or more characteristics of the second cell, the one or more capabilities including one or more of a radio access technology communications capability, one or more supported frequency ranges of the UE, or one or more supported network energy savings features.

8. The UE of claim 1, wherein the processing system is further configured to cause the UE to:
receive, from the first cell prior to transmission of the request to establish the connection with the second cell, configuration information associated with a random access procedure, wherein the configuration information indicates the request to establish the connection with the second cell is able to be transmitted in a first random access message or a third random access message of a four-step random access procedure, or in an initial random access message of a two-step random access procedure.

9. The UE of claim 1, wherein the processing system is further configured to cause the UE to:
identify the second cell based at least in part on one or more measurements associated with the second cell that are stored at the UE, or based at least in part on a prior connection between the UE and the second cell.

10. The UE of claim 1, wherein the processing system is further configured to cause the UE to:
receive, from the first cell, configuration information associated with the second cell that indicates one or more of a measurement configuration associated with the second cell, a reference signal configuration associated with the second cell, or timing information associated with the second cell.

11. The UE of claim 1, wherein the response message is received from the second cell via the first cell and indicates the first cell will relay communications between the UE and the second cell until the connection between the UE and the second cell is established.

12. The UE of claim 11, wherein the processing system is further configured to cause the UE to:
establish a security context with the second cell in accordance with communications between the UE and the second cell that are relayed via the first cell.

13. The UE of claim 11, wherein the response message provides configuration information for the second cell and indicates the second cell is in a deactivated state, and wherein a subsequent radio resource control configuration message indicates the second cell is activated.

14. The UE of claim 1, wherein the second cell is a network energy saving (NES) cell and the first cell is an anchor cell, wherein a cell coverage area of the anchor cell overlaps at least in part with a cell coverage area of the NES cell.

15. A method for wireless communications at a user equipment (UE), comprising:
transmitting a random access message to a first cell, wherein the random access message includes a request to establish a connection with a second cell that is different than the first cell, wherein the second cell is unavailable for a random access procedure;
receiving a response message from the first cell that indicates an availability of the second cell for the connection with the UE; and
establishing, subsequent to reception of the response message, the connection with the second cell.

16. The method of claim 15, wherein the request to establish the connection with the second cell indicates one or more of a cell ID of the second cell, a beam ID of one or more beams associated with the second cell, cell frequency information associated with the second cell, or a cell type of the second cell.

17. The method of claim 15, further comprising:
performing one or more of a measurement procedure associated with the second cell, or a tuning procedure for one or more radio frequency components of the UE for communication with the second cell, based at least in part on the response message.

18. The method of claim 15, wherein the response message indicates an acceptance or a rejection of the request to establish the connection with the second cell.

19. A non-transitory computer-readable medium storing code for wireless communications, the code comprising instructions executable by one or more processors to:
transmit, from a user equipment (UE), a random access message to a first cell, wherein the random access message includes a request to establish a connection with a second cell that is different than the first cell, wherein the second cell is unavailable for a random access procedure;
receive a response message from the first cell that indicates an availability of the second cell for the connection with the UE; and
establish, subsequent to reception of the response message, the connection with the second cell.

20. The non-transitory computer-readable medium of claim 19, wherein the random access message indicates one or more of a selected beam or a measurement report parameter associated with the second cell, the selected beam or the measurement report parameter based at least in part on a prior measurement of the second cell performed at the UE.
